(19) United States
(12) Patent Application Publication
(10) Pub. No.: US 2026/0190158 A1
(43) Pub. Date: Jul. 2, 2026

(54) RANDOM ACCESS RESOURCE SET DETERMINATION METHOD AND APPARATUS, AND TERMINAL

(71) Applicant: VIVO MOBILE COMMUNICATION CO., LTD., Guangdong (CN)

(72) Inventors: Tingting ZHONG, Guangdong (CN); Wei BAO, Guangdong (CN); Li CHEN, Guangdong (CN)

(73) Assignee: VIVO MOBILE COMMUNICATION CO., LTD., Guangdong (CN)

(21) Appl. No.: 19/543,690

(22) Filed: Feb. 18, 2026

Related U.S. Application Data
(63) Continuation of application No. PCT/CN2024/113521, filed on Aug. 21, 2024.

(30) Foreign Application Priority Data
Aug. 25, 2023 (CN) 202311081815.2

(51) Int. Cl. H04W 74/0836

(52) U.S. Cl. CPC H04W 74/0836

(57) ABSTRACT

A random access resource set determination method and apparatus, and a terminal. The random access resource set determination method according to embodiments of the present application includes: performing, by a terminal, an availability determination operation on a random access resource set, where the availability determination operation includes: determining, based on whether the random access resource set is associated with at least one of eRedCap and RedCap, a random access procedure for which the random access resource set is not available.

### CROSS-REFERENCE TO RELATED APPLICATIONS

This application is a continuation of International Patent Application No. PCT/CN2024/113521 filed on Aug. 21, 2024, which claims priority to Chinese Patent Application No. 202311081815.2 filed on Aug. 25, 2023, which are incorporated herein by reference in their entireties.

### TECHNICAL FIELD

The present application relates to the technical field of communication, and in particular, to a random access resource set determination method and apparatus, and a terminal.

### BACKGROUND

In some communication systems, multiple types of terminals are supported, such as conventional terminals, enhanced reduced capability (eRedCap) terminals, and reduced capability (RedCap) terminals, such that multiple types of random access procedures also exist. In some related art, due to the existence of multiple types of random access procedures, a terminal is unable to determine the availability of a random access resource set, affecting the random access performance of the terminal.

### SUMMARY

Embodiments of the present application provide a random access resource set determination method and apparatus, and a terminal.

In a first aspect, there is provided a random access resource set determination method, including:

performing, by a terminal, an availability determination operation on a random access resource set, where the availability determination operation includes:

determining, based on whether the random access resource set is associated with at least one of eRedCap and RedCap, a random access procedure for which the random access resource set is not available.

In a second aspect, there is provided a random access resource set determination apparatus, including:

a determination module, configured to perform an availability determination operation on a random access resource set, where the availability determination operation includes:

determining, based on whether the random access resource set is associated with at least one of eRedCap configuration and RedCap, a random access procedure for which the random access resource set is not available.

In a third aspect, there is provided a terminal including a processor and a memory, the memory storing programs or instructions executable by the processor, and the programs or instructions, when executed by the processor, implementing steps of the random access resource set determination method according to the embodiments of the present application.

In a fourth aspect, there is provided a terminal including a processor and a communication interface, the processor being configured to perform an availability determination operation on a random access resource set, where the availability determination operation includes: determining, based on whether the random access resource set is associated with at least one of eRedCap configuration and RedCap, a random access procedure for which the random access resource set is not available.

In a fifth aspect, there is provided a readable storage medium having programs or instructions stored therein, the programs or the instructions, when executed by a processor, implementing steps of the random access resource set determination method according to the embodiments of the present application.

In a sixth aspect, there is provided a chip including a processor and a communication interface, the communication interface being coupled to the processor, and the processor being configured to execute programs or instructions to implement the random access resource set determination method according to the embodiments of the present application.

In a seventh aspect, there is provided a computer program/program product stored in a storage medium, the program/program product being executed by at least one processor to implement steps of the random access resource set determination method according to the embodiments of the present application.

### BRIEF DESCRIPTION OF THE DRAWINGS

FIG. 1 is a block diagram of a wireless communication system that can be applied to an embodiment of the present application;

FIG. 2 is a flowchart of a random access resource set determination method according to an embodiment of the present application;

FIG. 3 is a structural diagram of a random access resource set determination apparatus according to an embodiment of the present application;

FIG. 4 is a structural diagram of a communication device according to an embodiment of the present application; and

FIG. 5 is a structural diagram of a terminal according to an embodiment of the present application.

### DETAILED DESCRIPTION

Technical solutions in embodiments of the present application are clearly described below with reference to the drawings in the embodiments of the present application. It is apparent that the described embodiments are merely part of rather than all of the embodiments of the present application. All other embodiments obtained by a person of ordinary skill in the art based on the embodiments of the present application fall within the scope of protection of the present application.

The terms “first”, “second”, and the like in the present application are used to distinguish similar objects and are not intended to describe any specific order or sequence. It is to be understood that such terms used herein are interchangeable as appropriate, so that the embodiments of the present application can be implemented in sequences other than those illustrated or described herein. The objects distinguished by “first”, “second”, and the like are generally of the same type and are not limited in number, for example, a first object may be one or more. In addition, the term “or” in the present application denotes at least one of the connected objects. For example, “A or B” encompasses three scenarios: scenario one: including A but not B; scenario two: including B but not A; and scenario three: including both A and B. The character “/” generally denotes an “or” relationship between the associated objects.

The term “indicate” in the present application may refer to either a direct indication (i.e., an explicit indication) or an indirect indication (i.e., an implicit indication). The direct indication can be understood as a sender explicitly informing a receiver of specific information, operations to be performed, requested results, or the like in the transmitted indication. The indirect indication can be understood as the receiver determining, according to the indication transmitted by the sender, the corresponding information, or making a determination and determining, based on the determination, the operations to be performed or the requested results.

It is to be noted that the technology described in the embodiments of the present application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or other systems. The terms “system” and “network” in the embodiments of the present application are often used interchangeably. The described technology can be applied not only to the systems and radio technologies described above, but also to other systems and radio technologies. The following description illustrates a new radio (NR) system for exemplary purposes, and NR terminology is used in most of the subsequent description. However, these technologies may be applied to systems other than NR systems, such as 6^{th} generation (6G) communication systems.

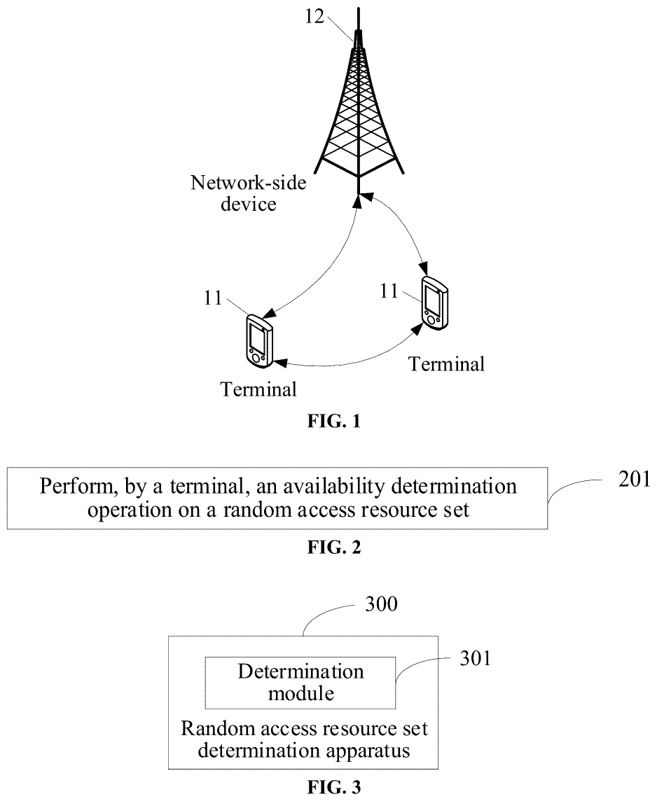

FIG. 1 shows a block diagram of a wireless communication system that can be applied to an embodiment of the present application. The wireless communication system includes a terminal 11 and a network-side device 12. The terminal 11 may be a terminal-side device, such as a mobile phone, tablet personal computer, laptop computer, notebook computer, personal digital assistant (PDA), handheld computer, netbook, ultra-mobile personal computer (UMPC), mobile Internet device (MID), augmented reality (AR) device, virtual reality (VR) device, robot, wearable device, flight vehicle, vehicle user equipment (VUE), shipborne device, pedestrian user equipment (PUE), smart home device (home device with wireless communication capabilities, such as a refrigerator, television, washing machine, or furniture), game console, personal computer (PC), automated teller machine, or self-service terminal. The wearable devices include smart watches, smart wristbands, smart earphones, smart glasses, smart jewelry (such as smart bracelets, smart bangles, smart rings, smart necklaces, smart anklets, and smart foot chains), smart bands, smart clothing, and the like. The vehicle user equipment may be referred to as a vehicle terminal, vehicle controller, vehicle module, vehicle component, vehicle chip, vehicle unit, or the like. It is to be noted that the embodiments of the present application do not limit the specific type of the terminal 11.

The network-side device 12 may include an access network device or a core network device, where the access network device may be referred to as a radio access network (RAN) device, a radio access network function, or a radio access network unit. The access network device may include a base station, a wireless local area network (WLAN) access point (AP), a wireless fidelity (WiFi) node, or the like. The base station may be referred to as node B (NB), evolved node B (eNB), the next generation node B (gNB), new radio node B (NR Node B), access point, relay base station (RBS), serving base station (SBS), base transceiver station (BTS), radio base station, radio transceiver, basic service set (BSS), extended service set (ESS), home node B (HNB), home evolved node B, transmission reception point (TRP), or any other suitable term in the field, provided the same technical effect is achieved. The base station is not limited to a specific technical term. It is to be noted that, in the embodiments of the present application, the base station in an NR system is used merely as an example for illustration, and the specific type of the base station is not limited.

The core network device may include, but is not limited to, at least one of the following: core network nodes, core network functions, mobility management entity (MME), access and mobility management function (AMF), session management function (SMF), user plane function (UPF), policy control function (PCF), policy and charging rules function (PCRF), edge application server discovery function (EASDF), unified data management (UDM), unified data repository (UDR), home subscriber server (HSS), centralized network configuration (CNC), network repository function (NRF), network exposure function (NEF), local NEF (L-NEF), binding support function (BSF), application function (AF), and the like. It is to be noted that in the embodiments of the present application, the core network device in the NR system is used merely as an example for illustration, and the specific type of the core network device is not limited.

In some embodiments, the network side may allocate specific message 1(msg1 ) (for a four-step random access procedure) or message A (msgA) (for a two-step random access procedure) random access resources to random access channel (RACH) procedures associated with different features. This allows the network side, upon receiving msg1 or msgA, to determine some features of the corresponding random access according to the resources carrying msg1 or msgA, and to perform corresponding operations, for example, relevant information may be considered when generating and transmitting message 2 (msg2 ) or message B (msgB).

In some embodiments, for eRedCap, an eRedCap terminal shares the physical random access channel (PRACH) resources of a RedCap terminal when the associated RACH msg1 resource is not configured for the eRedCap-specific Msg1 early indication (eRedCap-specific Msg1early indication) but the associated RACH msg1 resource is configured for the RedCap-specific Msg1 early indication (RedCap-specific Msg1early indication). Moreover, if the network is configured with the Rel-17 RedCap specific msgA (Rel-17 RedCap specific msgA) resource, the eRedCap UE shares the Rel-17 RedCap specific msgA (Rel-17 RedCap specific msgA) resource.

Therefore, when initiating a RACH, the available resources of the eRedCap terminal include at least one of the following:

a msg1 resource set associated with eRedCap features (for four-step random access);

a msg1 resource set associated with RedCap features (for four-step random access);

a msgA resource set associated with RedCap features (for two-step random access); and

a msg1 or msgA resource set not associated with either eRedCap or RedCap.

In some embodiments, the network side may allocate specific msg1 (for a four-step random access procedure) or msgA (for a two-step random access procedure) random access resources to RACH procedures associated with small data transmission (SDT), RedCap, coverage enhancement (CovEnh), or slicing. The msg1 or msgA random access resources described above are associated with one or multiple feature combinations in the above embodiments.

For example, if the random access procedure initiated by the terminal is associated with SDT and RedCap, and the random access procedure is not associated with CovEnh (for example, a RACH procedure triggered by an SDT procedure initiated by a RedCap terminal), an example illustrating the selection of RACH resources by the terminal is as follows:

If the random access resources configured by the network include one or more of the following four types:
A. a msg1 or msgA resource set applicable to the SDT and RedCap feature combination;
B. a msg1 or msgA resource set applicable to RedCap features;
C. a msg1 or msgA resource set applicable to SDT and RedCap features;
D. a msg1 or msgA resource set applicable to the SDT, RedCap, and CovEnh feature combination;
E. a msg1 or msgA resource set not associated with any feature.

The behavior of the terminal may include at least one of the following:

If the random access resources configured by the network include A, the terminal selects the random access resource set configured in A for random access.

If the random access resources configured by the network include D, the terminal does not select the random access resource set configured in D for random access, because this RACH is not related to CovEnh, and selecting the random access resources configured in D may cause misinterpretation by the network.

If the random access resources configured by the network do not include A, but include B and/or C, the terminal selects the random access resource set configured in B or C for random access; if the random access resources configured by the network include both B and C, the specific selection between B and C depends on other network configurations.

If the random access resources configured by the network include none of A, B, or C, the UE selects the random access resource set configured in E for random access.

The selection of a random access resource set requires determining the availability of the random access resource set and selecting a random access resource set based on priorities of features.

For example, the msg1 or msgA resources applicable to the SDT and RedCap feature combination form a random access resource set, which specifically includes time-frequency locations of random access occasions (RACH Occasion, RO) and a set of preambles, etc.

For example, a process such as selecting a random access resource set based on the priority of at least one feature, including SDT, RedCap, CovEnh, and Slicing.

When the random access resource set selected by the terminal includes both msg1 and msgA resources, a selection between the two can be made through other mechanisms.

For msg1 or msgA resources in a resource set, the network configures the applicable scopes through the following information elements (IE):
FeatureComination-r17: :=SEAUENCE{
redcap-r17 ENUMERATED{true} OPRIONAL,--Need R
smallData-r17 ENUMERATED{true} OPRIONAL,--Need R
nsag-r17 ENUMERATED{true} OPRIONAL,--Need R
msg3-Repetitions-r17 ENUMERATED{true} OPRIONAL,--Need R
spare4 ENUMERATED{true} OPRIONAL,--Need R
spare4 ENUMERATED{true} OPRIONAL,--Need R
spare4 ENUMERATED{true} OPRIONAL,--Need R
spare4 ENUMERATED{true} OPRIONAL,--Need R
}

Setting redCap-r17 to true (when the redCap-r17 IE is carried, which is equivalent to being set to true) indicates that the corresponding RACH resource is only used for redCap.

Similarly, setting smallData-r17 to true indicates that the corresponding RACH resource is only used for SDT.

If redCap-r17 and smallData-r17 are both carried, while the others are not carried, it indicates that the corresponding RACH resource is only used for the combination of redCap and small data (smallData). All initiated RACHs that are associated with both RedCap and smallData (and optionally with other third features) can use the corresponding RACH resource.

In some embodiments, the eRedCap may use one of the above spare1 to spare4.

It is to be noted that the above IEs are provided merely as examples, and the configuration of resources is not limited in the embodiments of the present application.

In some embodiments, the cost and complexity of a device with reduced capability (RedCap) may be further reduced. One of the methods is to reduce the terminal bandwidth so that it supports only 5 MHz.

For example, considering impacts on the network, the coexistence of RedCap (which may include RedCap corresponding to multiple protocol versions) and non-RedCap terminals within a cell, as well as impacts on terminals or specifications, potential solutions that may be mutually complementary are proposed to reduce device complexity, as detailed below.

The terminal bandwidth is reduced to 5 MHz in the frequency range (FR) 1. In this case, it may be combined with relaxed processing times for the terminal regarding the physical downlink shared channel (PDSCH), the physical uplink shared channel (PUSCH), and/or channel state information (CSI).

Alternatively, the terminal peak data rate in FR1 may be reduced. In this case, this may include limitations on the allocated bandwidth for PDSCH and/or PUSCH, or may be combined with relaxed processing timelines for the terminal regarding PDSCH, PUSCH, or CSI.

It is to be noted that the above embodiments can also be applied to FR2.

In some embodiments, when further reducing the bandwidth (BW) of a RedCap terminal to 5 MHz, the following three main options are provided.

Option BW1: For both uplink (UL) and downlink (DL), the radio frequency (RF) and baseband (BB) bandwidths are both 5 MHz. It is characterized in that the RF is tuned to the 5 MHz BW of interest. If the position of the 5 MHz BW of the RF changes, the RF needs to be reconfigured.

Option BW2: The baseband bandwidth is 5 MHz for all signals and channels, while the radio frequency bandwidth remains 20 MHz for both uplink (UL) and downlink (DL). It is characterized in that the ADC/FFT BW matches the RF BW, making it easier to adjust the position of the 5 MHz BW of interest in the digital domain. Compared to BW1, no RF reconfiguration is required.

Option BW3: The baseband bandwidth is 5 MHz only for PDSCH (unicast and broadcast) and PUSCH, while the radio frequency bandwidth is 20 MHz for both UL and DL. Except for the above PDSCH and PUSCH, other physical channels, such as the synchronization signal block (SSB), physical downlink control channel (PDCCH), PRACH, physical uplink control channel (PUCCH), and reference signals (e.g., CSI-RS, SRS), are still allowed to use 20 MHz as the maximum radio frequency bandwidth. It is characterized in that the control channels can transmit over a bandwidth larger than 20 MHz, with buffering for control channels maintained at 20 MHz. This provides limited cost savings for post fast Fourier transform (Post-FFT) data buffering and receiver processing blocks, but offers greater flexibility in the resource configuration, allocation, and scheduling of channels and signals.

It is to be noted that the above embodiments are provided merely as examples to illustrate the technical solutions according to the embodiments of the present application, and do not in any way limit the technical solutions according to the embodiments of the present application.

The following description, with reference to the drawings, provides a detailed description of the random access resource set determination method and apparatus, and terminal according to the embodiments of the present application through some embodiments and the application scenarios.

Referring to FIG. 2, FIG. 2 is a flowchart of a random access resource set determination method according to an embodiment of the present application. As shown in FIG. 2, the method includes the following steps.

Step 201: A terminal performs an availability determination operation on a random access resource set, where the availability determination operation includes:

determining, based on whether the random access resource set is associated with at least one of eRedCap and RedCap, a random access procedure for which the random access resource set is not available.

The above random access resource set may be any random access resource set corresponding to the terminal, that is, the terminal can perform the above step 201 for each access resource set.

The above availability determination operation may be referred to as a usability determination operation.

The determining, based on whether the random access resource set is associated with at least one of eRedCap and RedCap, a random access procedure for which the random access resource set is not available includes the following three ways:

determining, based on whether the random access resource set is associated with eRedCap, a random access procedure for which the random access resource set is not available;

determining, based on whether the random access resource set is associated with RedCap, a random access procedure for which the random access resource set is not available; and

determining, based on whether the random access resource set is associated with eRedCap and RedCap, a random access procedure for which the random access resource set is not available.

In some implementations, an eRedCap indication corresponding to the random access resource set is true, indicating that the random access resource set is associated with eRedCap; conversely, the random access resource set is not associated with eRedCap.

The eRedCap indication corresponding to the above random access resource set being true may either be that the configuration corresponding to the random access resource set carries the eRedCap indication, or that the configuration corresponding to the random access resource set carries an indication that eRedCap is true.

In some implementations, the configuration corresponding to the random access resource set may indicate eRedCap by 1 bit, where a first value (1 or 0) indicates that the eRedCap indication is carried, and a second value (0 or 1) indicates that the eRedCap indication is not carried.

In some implementations, a random access resource set being associated with eRedCap may indicate that the resource set is available only to the eRedCap terminal.

In some implementations, a RedCap indication corresponding to the random access resource set is true, indicating that the random access resource set is associated with RedCap; conversely, the random access resource set is not associated with RedCap.

The RedCap indication corresponding to the above random access resource set being true may either be that the configuration corresponding to the random access resource set carries the RedCap indication, or that the configuration corresponding to the random access resource set carries an indication that RedCap is true.

In some implementations, the configuration corresponding to the random access resource set may indicate RedCap by 1 bit, where a first value (1 or 0) indicates that the RedCap indication is carried, and a second value (0 or 1) indicates that the RedCap indication is not carried.

In some implementations, the configuration corresponding to the random access resource set described above may be the configuration received by the terminal from a network-side device.

It is to be noted that the embodiments of the present application do not limit the specific implementations of determining whether the random access resource set is associated with eRedCap and RedCap. For example, the above eRedCap indication and RedCap indication, or other configuration methods, may be used to indicate whether the random access resource set is associated with eRedCap and RedCap.

In some implementations, the determining a random access procedure for which the random access resource set is not available described above may further allow the terminal to determine random access procedures other than the unavailable random access procedure as available. For example, all or part of the random access procedures other than the default unavailable random access procedure may be available, or protocol-predefined random access procedures other than the default unavailable random access procedure may be available.

In some implementations, step 201 described above may be performed by a medium access control entity of the terminal.

In the embodiments of the present application, the terminal performs an availability determination operation on a random access resource set, where the availability determination operation includes: determining, based on whether the random access resource set is associated with at least one of eRedCap and RedCap, a random access procedure for which the random access resource set is not available. Based on whether the random access resource set is associated with at least one of eRedCap and RedCap, a random access procedure for which the random access resource set is not available is determined, thereby avoiding the terminal from initiating an unavailable random access procedure on the random access resource set, which may lead to random access failure of the terminal, and thus enhancing the random access performance of the terminal. For example, this can enhance the success rate of the random access of the terminal and reduce the power consumption of the terminal for random access procedures, thereby enhancing the random access performance of the terminal.

As an optional implementation, the method further includes:

performing an available random access procedure for a random access resource in the random access resource set, where the available random access procedure does not include the unavailable random access procedure, specifically a random access procedure other than the unavailable random access procedure.

As an optional implementation, the above random access resource set includes:

any random access resource set of random access resource sets indicated to the terminal.

The random access resource set indicated to the terminal is a random access resource set indicated by the network side to the terminal, which may specifically include one or more random access resource sets.

In this implementation, since any random access resource set of the random access resource sets indicated to the terminal is involved, the availability determination operation of the above steps can be performed for each random access resource set.

As an optional implementation, the random access resource set includes at least one of the following:

a resource set including only four-step random access resources, a resource set including only two-step random access resources, and a resource set including both four-step random access resources and two-step random access resources.

In this implementation, a corresponding availability determination operation can be performed for each of the three types of random access resource sets described above, thereby further enhancing the random access performance of the terminal.

It is to be noted that in the following implementations, if the type of the random access resource set is not explicitly specified, it is assumed by default that all three types of random access resource sets described above are applicable, which are not further described herein.

As an optional implementation, the determining, based on whether the random access resource set is associated with at least one of eRedCap and RedCap, a random access procedure for which the random access resource set is not available includes at least one of the following:

in a case that the random access resource set is associated with eRedCap, determining a random access procedure for which the random access resource set is not available includes a random access procedure for which eRedCap is not applicable.

The random access procedure for which eRedCap is not applicable described above can be understood as a random access procedure currently initiated by a terminal that is not an eRedCap terminal.

In this implementation, when the random access resource set is associated with eRedCap, determining a random access procedure for which the random access resource set is not available includes a random access procedure for which eRedCap is not applicable, so that the terminal uses a random access procedure for which eRedCap is applicable, thereby enhancing the reliability of the random access of the terminal.

As an optional implementation, the terminal is an eRedCap terminal, and the method further includes at least one of the following:

in a case that the random access resource set is not associated with eRedCap, the terminal regards the terminal as a RedCap terminal to perform at least one of the following:

performing an availability determination operation on the random access resource set; and selecting, based on priorities of features, a random access resource set.

The terminal being regarded as a RedCap terminal may refer to that the eRedCap terminal regards itself as a RedCap terminal to perform the at least one operation described above, or the terminal being regarded as a RedCap terminal may refer to that the eRedCap terminal regards RedCap as RedCap.

The terminal being regarded as a RedCap terminal to perform the at least one operation described above may refer to that the terminal is regarded as a RedCap terminal when performing an availability determination operation on the random access resource set or when selecting a random access resource set based on priorities of features.

The availability determination operation performed on the random access resource set described above may be the availability determination operation in step 201, or may be another availability determination operation defined by a protocol.

The selecting a random access resource set based on priorities of features described above may be a protocol-defined procedure for selecting a random access resource set based on priorities of features.

In this implementation, by regarding the terminal as a RedCap terminal when performing an availability determination operation on the random access resource set or when selecting a random access resource set based on priorities of features, the random access performance of the eRedCap terminal can be enhanced.

As an optional implementation, the terminal is an eRedCap terminal, and in a case that the random access resource set is not associated with eRedCap, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap is not applicable;

in a case that the random access resource set is associated with RedCap and the random access resource set includes only two-step random access resources, determining a random access procedure for which the random access resource set is not available includes a random access procedure for which eRedCap is not applicable; and

in a case that the random access resource set is associated with RedCap and the random access resource set includes only two-step random access resources, determining a random access procedure for which the random access resource set is not available includes a random access procedure for which eRedCap is not applicable and a random access procedure for which RedCap is not applicable.

The random access resource set including four-step random access resources described above may mean that the random access resource set includes only four-step random access resources, or the random access resource set includes four-step random access resources and two-step random access resources.

In this implementation, in a case that the random access resource set is associated with RedCap, for a random access resource set including four-step random access resources or two-step random access resources, determining a random access procedure for which the random access resource set is not available includes a random access procedure for which eRedCap is not applicable, thereby enhancing the random access performance of the eRedCap terminal.

Optionally, the in a case that the random access resource set is associated with RedCap and the random access resource set includes only two-step random access resources, determining a random access procedure for which the random access resource set is not available includes a random access procedure for which eRedCap is not applicable includes:

in a case that the random access resource set is associated with RedCap, the random access resource set includes only two-step random access resources, and the two-step random access resources satisfy a first condition, determining a random access procedure for which the random access resource set is not available includes a random access procedure for which eRedCap is not applicable;

or

the in a case that the random access resource set is associated with RedCap and the random access resource set includes only two-step random access resources, determining a random access procedure for which the random access resource set is not available includes a random access procedure for which eRedCap is not applicable and a random access procedure for which RedCap is not applicable includes:

in a case that the random access resource set is associated with RedCap, the random access resource set includes only two-step random access resources, and the two-step random access resources satisfy a first condition, determining a random access procedure for which the random access resource set is not available includes a random access procedure for which eRedCap is not applicable and a random access procedure for which RedCap is not applicable,

where the first condition includes that part or all of time-frequency resources for transmitting message A of the two-step random access resources do not exceed a capability of the terminal.

The above first condition may be a protocol-defined condition or a network-side-configured condition.

Part or all of the time-frequency resources for transmitting message A of the two-step random access resources do not exceed the capability of the terminal, which can be understood that part or all of the time-frequency resources for transmitting message A of the two-step random access resources fall within the capability of the above terminal.

In this implementation, through the above first condition, the determination of the random access procedure for which the random access resource set is not available can be made more precise, thereby further enhancing the random access performance of the terminal.

As an optional implementation, the determining, based on whether the random access resource set is associated with at least one of eRedCap and RedCap, a random access procedure for which the random access resource set is not available includes at least one of the following:

in a case that all random access resource sets indicated to the terminal and including four-step random access resources are not associated with eRedCap, the random access resource set is associated with RedCap, and the random access resource set includes four-step random access resources, determining a random access procedure for which the random access resource set is not available includes a random access procedure for which eRedCap or RedCap is not applicable; and

in a case that all random access resource sets indicated to the terminal and including four-step random access resources are not associated with eRedCap, the random access resource set is associated with RedCap, and the random access resource set includes only two-step random access resources, determining a random access procedure for which the random access resource set is not available includes a random access procedure for which eRedCap or RedCap is not applicable.

The random access resource set indicated to the terminal and including four-step random access resources described above may be all random access resource sets indicated to the terminal and including four-step random access resources.

The random access procedure for which RedCap is not applicable described above can be understood as a random access procedure currently initiated by a terminal that is not a RedCap terminal.

In this implementation, the random access resource set refers to the random access resource set in step 201.

The random access procedure for which eRedCap or RedCap is not applicable described above refers to a random access procedure for which eRedCap is not applicable, or a random access procedure for which RedCap is not applicable.

In this implementation, in a case that all random access resource sets indicated to the terminal and including four-step random access resources are not associated with eRedCap, the above random access resource set is associated with RedCap, and the random access resource set includes four-step random access resources, determining a random access procedure for which the random access resource set is not available includes a random access procedure for which eRedCap or RedCap is not applicable, thereby enhancing the random access performance of the terminal.

In this implementation, in a case that all random access resource sets indicated to the terminal and including four-step random access resources are not associated with eRedCap, the above random access resource set is associated with RedCap, and the random access resource set includes only two-step random access resources, determining a random access procedure for which the above random access resource set is not available includes a random access procedure for which eRedCap or RedCap is not applicable, thereby enhancing the random access performance of the terminal.

Optionally, the in a case that all random access resource sets indicated to the terminal and including four-step random access resources are not associated with eRedCap, the random access resource set is associated with RedCap, and the random access resource set includes only two-step random access resources, determining a random access procedure for which the random access resource set is not available includes a random access procedure for which eRedCap or RedCap is not applicable includes:

in a case that all random access resource sets indicated to the terminal and including four-step random access resources are not associated with eRedCap, the random access resource set is associated with RedCap, the random access resource set includes only two-step random access resources, and the two-step random access resources satisfy a second condition, determining a random access procedure for which the random access resource set is not available includes a random access procedure for which eRedCap or RedCap is not applicable, where the second condition includes that part or all of time-frequency resources for transmitting message A of the two-step random access resources do not exceed a capability of the terminal.

The above second condition may be a protocol-defined condition or a network-side-configured condition.

In this implementation, through the above second condition, the determination of the random access procedure for which the random access resource set is not available can be made more precise, thereby further enhancing the random access performance of the terminal.

As an optional implementation, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap or RedCap is not applicable; and

in a case that the random access resource set is associated with RedCap and the random access resource set includes only two-step random access resources, determining a random access procedure for which the random access resource set is not available includes a random access procedure for which eRedCap or RedCap is not applicable.

In this implementation, in a case that the random access resource set is associated with RedCap, for a random access resource set including four-step random access resources or two-step random access resources, determining a random access procedure for which the random access resource set is not available includes a random access procedure for which eRedCap or RedCap is not applicable, thereby enhancing the random access performance of the terminal.

Optionally, the in a case that the random access resource set is associated with RedCap and the random access resource set includes only two-step random access resources, determining a random access procedure for which the random access resource set is not available includes a random access procedure for which eRedCap or RedCap is not applicable includes:

in a case that the random access resource set is associated with RedCap, the random access resource set includes only two-step random access resources, and the two-step random access resources satisfy a third condition, determining a random access procedure for which the random access resource set is not available includes a random access procedure for which eRedCap or RedCap is not applicable, where the third condition includes that part or all of time-frequency resources for transmitting message A of the two-step random access resources do not exceed a capability of the terminal.

The above third condition may be a protocol-defined condition or a network-side-configured condition.

In this implementation, through the above third condition, the determination of the random access procedure for which the random access resource set is not available can be made more precise, thereby further enhancing the random access performance of the terminal.

As an optional implementation, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap or RedCap is not applicable; and

in a case that the random access resource set is associated with RedCap and the random access resource set includes only two-step random access resources, determining a random access procedure for which the random access resource set is not available includes a random access procedure for which eRedCap or RedCap is not applicable.

In this implementation, when the random access resource set is a resource set including only two-step random access resources or including four-step random access, the random access procedure for which the random access resource set is not available can be determined, thereby enhancing the random access performance of the terminal.

Optionally, the in a case that the random access resource set is associated with RedCap and the random access resource set includes only two-step random access resources, determining a random access procedure for which the random access resource set is not available includes a random access procedure for which eRedCap or RedCap is not applicable includes:

in a case that the random access resource set is associated with RedCap, the random access resource set includes only two-step random access resources, and the two-step random access resources satisfy a fourth condition, determining a random access procedure for which the random access resource set is not available includes a random access procedure for which eRedCap or RedCap is not applicable, where the fourth condition includes that part or all of time-frequency resources for transmitting message A of the two-step random access resources do not exceed a capability of the terminal.

The above fourth condition may be a protocol-defined condition or a network-side-configured condition.

In this implementation, through the above fourth condition, the determination of the random access procedure for which the random access resource set is not available can be made more precise, thereby further enhancing the random access performance of the terminal.

As an optional implementation, the method further includes:

determining, based on whether the random access resource set is associated with at least one of eRedCap and RedCap, a random access procedure for which the random access resource set is available.

For example, in a case that the random access resource set is associated with eRedCap, determining a random access procedure for which the random access resource set is available includes a random access procedure for which eRedCap is applicable.

In a case that the random access resource set is associated with RedCap, determining a random access procedure for which the random access resource set is available includes a random access procedure for which RedCap is applicable.

In the embodiments of the present application, the terminal performs an availability determination operation on a random access resource set, where the availability determination operation includes: determining, based on whether the random access resource set is associated with at least one of eRedCap and RedCap, a random access procedure for which the random access resource set is not available. Based on whether the random access resource set is associated with at least one of eRedCap and RedCap, a random access procedure for which the random access resource set is not available is determined, thereby avoiding the terminal from initiating an unavailable random access procedure on the random access resource set, which may lead to random access failure of the terminal, and thus enhancing the random access performance of the terminal.

The method according to the embodiments of the present application is illustrated below through multiple embodiments.

Embodiment 1. This embodiment mainly describes the availability of a random access resource set, as detailed below:
Step 1: The MAC entity of the terminal shall perform the following availability determination for each resource set configured with four-step random access resources.
Step 1-1: For a random access resource set, if eRedCap is set to true, the UE considers the random access resource set as not available for a random access procedure for which eRedCap is not applicable. Otherwise, in the subsequent steps of the availability determination process of the random access resource set and in the process of selecting a random access resource set based on priorities of features, the UE treats eRedCap as RedCap. That is, if the resource set is not applicable to eRedCap, the eRedCap terminal regards itself as a RedCap terminal and shares the resource sets available to the RedCap terminal.
Step 2: The MAC entity of the eRedCap terminal shall perform the following availability determination for each resource set configured with four-step random access resources or each resource set configured with two-step random access resources, as detailed below:

The MAC entity shall perform the following availability determination for each resource set configured with four-step random access resources (The MAC entity shall for each set of configured Random Access resources for 4-step RA type):
1> If eRedCap is set to true for a random access resource set (if eRedCap is set to true for a set of Random Access resources):
2> Consider the random access resource set as not available for a random access procedure for which eRedCap is not applicable (consider the set of Random Access resources as not available for a Random Access procedure for which eRedCap is not applicable).
1> Other:
2> Consider eRedCap as RedCap in the following procedure defined in clauses 5.1.1c and 5.1.1d (Consider eRedCap act as RedCap in the following procedure in clause 5.1.1c and 5.1.1d.).

The MAC entity shall perform the following availability determination for each resource set configured with four-step random access resources and each resource set configured with two-step random access resources (The MAC entity shall for each set of configured Random Access resources for 4-step RA type and for each set of configured Random Access resources for 2-step RA type):
1> If redCap is set to true for a random access resource set (if redCap is set to true for a set of Random Access resources):
2> Consider the random access resource set as not available for a random access procedure for which RedCap is not applicable (consider the set of Random Access resources as not available for a Random Access procedure for which RedCap is not applicable).
1> If small data (smallData) is set to true for a random access resource set (if smallData is set to true for a set of Random Access resources):
2> Consider the random access resource set as not available for a random access procedure that is not triggered for SDT (consider the set of Random Access resources as not available for the Random Access procedure which is not triggered for SDT).
1> If network slice as group (NSAG) list is configured for a random access resource set (if NSAG-List is configured for a set of Random Access resources):
2> Consider the random access resource set as not available for a random access procedure unless it is triggered for any one of the NSAG-IDs in the NSAG list (consider the set of Random Access resources as not available for the Random Access procedure unless it is triggered for any one of the NSAG-ID(s) in the NSAG-List).
1> If msg 3-Repetitions is set to true for a random access resource set (if msg 3-Repetitions is set to true for a set of Random Access resources):
2> Consider the random access resource set as not available for a random access procedure for which msg3 repetition is not applicable (consider the set of Random Access resources as not available for the Random Access procedure if Msg3 repetition is not applicable).
1> If a random access resource set is configured with a feature combination (if a set of Random Access resources is not configured with FeatureCombination):
2> Consider the random access resource set as not associated with any feature (consider the set of Random Access resources to not associated with any feature).

Embodiment 2:

This embodiment mainly describes the availability of a random access resource set, as detailed below:
Step 1: The MAC entity of the terminal shall perform the following availability determination for each resource set configured with four-step random access resources.
Step 1-1: For a random access resource set, if eRedCap is set to true, the UE considers the random access resource set as not available for a random access procedure for which eRedCap is not applicable.
Step 2: The MAC entity of the eRedCap terminal shall perform the following availability determination for each resource set configured with four-step random access resources and/or each resource set configured with two-step random access resources.
Step 2-1: For a resource set configured with two-step random access resources, if RedCap is set to true:
Step 2-1-1: The UE considers the random access resource set as not available for a random access procedure for which RedCap is not applicable.
Step 2-2:

For a resource set configured with four-step random access resources, if RedCap is set to true:
Step 2-2-1: The UE considers the random access resource set as not available for a random access procedure for which eRedCap or RedCap is not applicable.

The remaining procedures can refer to the protocol definition and are not described herein.

For example, the MAC entity shall perform the following availability determination for each resource set configured with four-step random access resources (The MAC entity shall for each set of configured Random Access resources for 4-step RA type):
1> If eRedCap is set to true for a random access resource set (if eRedCap is set to true for a set of Random Access resources):
2> Consider the random access resource set as not available for a random access procedure for which eRedCap is not applicable (consider the set of Random Access resources as not available for a Random Access procedure for which eRedCap is not applicable).

The MAC entity shall perform the following availability determination for each random access resource set configured with four-step random access resources and each random access resource set configured with two-step random access resources (The MAC entity shall for each set of configured Random Access resources for 4-step RA type and for each set of configured Random Access resources for 2-step RA type):
1> If redCap is set to true for a random access resource set of two-step random access type (if redCap is set to true for a set of Random Access resources for 2-step RA type):
2> Consider the random access resource set as not available for a random access procedure for which RedCap is not applicable (consider the set of Random Access resources as not available for a Random Access procedure for which RedCap is not applicable).
1> If redCap is set to true for a random access resource set of four-step random access type (if redCap is set to true for a set of Random Access resources for 4-step RA type):
2> Consider the random access resource set as not available for a random access procedure for which (e)RedCap is not applicable (consider the set of Random Access resources as not available for a Random Access procedure for which (e)RedCap is not applicable).

If redCap is set to true for a random access resource set of four-step random access type, as described above, it can be understood as eRedCap not being set to true, for example, in a feature combination, redCap and eRedCap are not both set to true.
1> If smallData is set to true for a random access resource set (if smallData is set to true for a set of Random Access resources):
2> Consider the random access resource set as not available for a random access procedure that is not triggered for SDT (consider the set of Random Access resources as not available for the Random Access procedure which is not triggered for SDT).
1> If the NSAG list is configured for a random access resource set (if NSAG-List is configured for a set of Random Access resources):
2> Consider the random access resource set as not available for a random access procedure unless it is triggered for any one of the NSAG-IDs in the NSAG list (consider the set of Random Access resources as not available for the Random Access procedure unless it is triggered for any one of the NSAG-ID(s) in the NSAG-List).
1> If msg 3-Repetitions is set to true for a random access resource set (if msg 3-Repetitions is set to true for a set of Random Access resources):
2> Consider the random access resource set as not available for a random access procedure for which msg3 repetition is not applicable (consider the set of Random Access resources as not available for the Random Access procedure if Msg3 repetition is not applicable).
1> If a random access resource set is configured with a feature combination (if a set of Random Access resources is not configured with FeatureCombination):
2> Consider the random access resource set as not associated with any feature (consider the set of Random Access resources to not associated with any feature).

Embodiment 3. This embodiment mainly describes the availability of a random access resource set, as detailed below:
Step 1: The MAC entity of the terminal shall perform the following availability determination for each resource set configured with four-step random access resources and/or each resource set configured with two-step random access resources.
Step 1-1: For a random access resource set, if eRedCap is set to true, the terminal considers the random access resource set as not available for a random access procedure for which eRedCap is not applicable; otherwise, the eRedCap terminal considers the random access resource set for which RedCap is set to true (if any) as not available for a random access procedure for which eRedCap is not applicable.
Step 2: The MAC entity of the eRedCap terminal shall perform the following availability determination for each resource set configured with four-step random access resources and each resource set configured with two-step random access resources. The specific contents of this step can refer to the protocol definition and are not described herein.

For example, the MAC entity shall perform the following availability determination for each resource set configured with four-step random access resources (The MAC entity shall for each set of configured Random Access resources for 4-step RA type):
1> If eRedCap is set to true for a random access resource set (if eRedCap is set to true for a set of Random Access resources):
2> Consider the random access resource set as not available for a random access procedure for which eRedCap is not applicable (consider the set of Random Access resources as not available for a Random Access procedure for which eRedCap is not applicable).
1> Other:
2> For eRedCap, consider the random access resource set for which RedCap is set to true (if any) as not available for a random access procedure for which eRedCap is not applicable (for eRedCap, consider the set of Random Access resources where redcap is set to true, if any, as not available for a Random Access procedure for which eRedCap is not applicable).

The MAC entity shall perform the following availability determination for each resource set configured with four-step random access resources or each resource set configured with two-step random access resources (The MAC entity shall for each set of configured Random Access resources for 4-step RA type and for each set of configured Random Access resources for 2-step RA type):
1> If redCap is set to true for a random access resource set (if redCap is set to true for a set of Random Access resources):
2> Consider the random access resource set as not available for a random access procedure for which RedCap is not applicable (consider the set of Random Access resources as not available for a Random Access procedure for which RedCap is not applicable).
1> If small data (smallData) is set to true for a random access resource set (if smallData is set to true for a set of Random Access resources):
2> Consider the random access resource set as not available for a random access procedure that is not triggered for SDT (consider the set of Random Access resources as not available for the Random Access procedure which is not triggered for SDT).
1> If network slice as group (network slice as group, NSAG) list is configured for a random access resource set (consider the set of Random Access resources as not available for the Random Access procedure which is not triggered for SDT):
2> Consider the random access resource set as not available for a random access procedure unless it is triggered for any one of the NSAG-IDs in the NSAG list (consider the set of Random Access resources as not available for the Random Access procedure unless it is triggered for any one of the NSAG-ID(s) in the NSAG-List).
1> If msg 3-Repetitions is set to true for a random access resource set (if msg 3-Repetitions is set to true for a set of Random Access resources):
2> Consider the random access resource set as not available for a random access procedure for which msg3 repetition is not applicable (consider the set of Random Access resources as not available for the Random Access procedure if Msg3 repetition is not applicable).
1> If a random access resource set is configured with a feature combination (if a set of Random Access resources is not configured with FeatureCombination):
2> Consider the random access resource set as not associated with any feature (consider the set of Random Access resources to not associated with any feature).

Embodiment 4:

This embodiment mainly describes the availability of a random access resource set, as detailed below:
Step 1: The MAC entity of the RedCap terminal shall perform the following availability determination for each resource set configured with four-step random access resources or each resource set configured with two-step random access resources.
Step 1-1: For a resource set configured with four-step random access resources, if eRedCap is set to true, the terminal considers the random access resource set as not available for a random access procedure for which eRedCap is not applicable.
Step 1-2: For a random access resource set configured with two-step random access resources, if RedCap is set to true,
Step 1-2-1: The terminal considers the random access resource set as not available for a random access procedure for which RedCap is not applicable.
Step 1-3: For a random access resource set configured with four-step random access resources, if RedCap is set to true,
Step 1-3-1: The terminal considers the random access resource set as not available for a random access procedure for which RedCap or eRedCap is not applicable.

The remaining steps can refer to the protocol definition and are not described herein.

For example:

The MAC entity shall perform the following availability determination for each resource set configured with four-step random access resources or each resource set configured with two-step random access resources (The MAC entity shall for each set of configured Random Access resources for 4-step RA type and for each set of configured Random Access resources for 2-step RA type):
1> If eRedCap is set to true for a random access resource set of four-step random access (if eRedCap is set to true for a set of Random Access resources for 4-step RA type):
2> Consider the random access resource set as not available for a random access procedure for which eRedCap is not applicable (consider the set of Random Access resources as not available for a Random Access procedure for which eRedCap is not applicable).
1> If eRedCap is set to true for a random access resource set of two-step random access (if redCap is set to true for a set of Random Access resources for 2-step RA type):
2> Consider the random access resource set as not available for a random access procedure for which eRedCap is not applicable (consider the set of Random Access resources as not available for a Random Access procedure for which eRedCap is not applicable).
1> If redCap is set to true for a random access resource set of four-step random access type (if redCap is set to true for a set of Random Access resources for 4-step RA type):
2> Consider the random access resource set as not available for a random access procedure for which (e)RedCap is not applicable (consider the set of Random Access resources as not available for a Random Access procedure for which (e)RedCap is not applicable).

If redCap is set to true for a random access resource set of four-step random access type, as described above, it can be understood as eRedCap not being set to true, for example, in a feature combination, redCap and eRedCap are not both set to true.
1> If smallData is set to true for a random access resource set (if smallData is set to true for a set of Random Access resources):
2> Consider the random access resource set as not available for a random access procedure that is not triggered for SDT (consider the set of Random Access resources as not available for the Random Access procedure which is not triggered for SDT).
1> If the NSAG list is configured for a random access resource set (if NSAG-List is configured for a set of Random Access resources):
2> Consider the random access resource set as not available for a random access procedure unless it is triggered for any one of the NSAG-IDs in the NSAG list (consider the set of Random Access resources as not available for the Random Access procedure unless it is triggered for any one of the NSAG-ID(s) in the NSAG-List).
1> If msg 3-Repetitions is set to true for a random access resource set (if msg 3-Repetitions is set to true for a set of Random Access resources):
2> Consider the random access resource set as not available for a random access procedure for which msg3 repetition is not applicable (consider the set of Random Access resources as not available for the Random Access procedure if Msg3 repetition is not applicable).
1> If a random access resource set is configured with a feature combination (if a set of Random Access resources is not configured with FeatureCombination):
2> Consider the random access resource set as not associated with any feature (consider the set of Random Access resources to not associated with any feature).

The random access resource set determination method according to the embodiments of the present application can be performed by a random access resource set determination apparatus. In the embodiments of the present application, the random access resource set determination apparatus according to the embodiments of the present application is illustrated in an example where the random access resource set determination apparatus performs the random access resource set determination method.

Referring to FIG. 3, FIG. 3 is a structural diagram of a random access resource set determination apparatus according to an embodiment of the present application. As shown in FIG. 3, the random access resource set determination apparatus 300 includes:

a determination module 301, configured to perform an availability determination operation on a random access resource set, where the availability determination operation includes:

determining, based on whether the random access resource set is associated with at least one of enhanced reduced capability eRedCap configuration and reduced capability RedCap, a random access procedure for which the random access resource set is not available.

Optionally, the random access resource set includes:

any random access resource set of random access resource sets indicated to the terminal.

Optionally, the random access resource set includes at least one of the following:

a resource set including only four-step random access resources, a resource set including only two-step random access resources, and a resource set including both four-step random access resources and two-step random access resources.

Optionally, the determining, based on whether the random access resource set is associated with at least one of eRedCap and RedCap, a random access procedure for which the random access resource set is not available includes at least one of the following:

in a case that the random access resource set is associated with eRedCap, determining a random access procedure for which the random access resource set is not available includes a random access procedure for which eRedCap is not applicable.

Optionally, the terminal is an eRedCap terminal, and the method further includes at least one of the following:

in a case that the random access resource set is not associated with eRedCap, the terminal regards the terminal as a RedCap terminal to perform at least one of the following:

performing an availability determination operation on the random access resource set; and selecting, based on priorities of features, a random access resource set.

Optionally, the terminal is an eRedCap terminal, and in a case that the random access resource set is not associated with eRedCap, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap is not applicable;

in a case that the random access resource set is associated with RedCap and the random access resource set includes only two-step random access resources, determining a random access procedure for which the random access resource set is not available includes a random access procedure for which eRedCap is not applicable; and

in a case that the random access resource set is associated with RedCap and the random access resource set includes only two-step random access resources, determining a random access procedure for which the random access resource set is not available includes a random access procedure for which eRedCap is not applicable and a random access procedure for which RedCap is not applicable.

Optionally, the in a case that the random access resource set is associated with RedCap and the random access resource set includes only two-step random access resources, determining a random access procedure for which the random access resource set is not available includes a random access procedure for which eRedCap is not applicable includes:

in a case that the random access resource set is associated with RedCap, the random access resource set includes only two-step random access resources, and the two-step random access resources satisfy a first condition, determining a random access procedure for which the random access resource set is not available includes a random access procedure for which eRedCap is not applicable;

or

the in a case that the random access resource set is associated with RedCap and the random access resource set includes only two-step random access resources, determining a random access procedure for which the random access resource set is not available includes a random access procedure for which eRedCap is not applicable and a random access procedure for which RedCap is not applicable includes:

in a case that the random access resource set is associated with RedCap, the random access resource set includes only two-step random access resources, and the two-step random access resources satisfy a first condition, determining a random access procedure for which the random access resource set is not available includes a random access procedure for which eRedCap is not applicable and a random access procedure for which RedCap is not applicable,

where the first condition includes that part or all of time-frequency resources for transmitting message A of the two-step random access resources do not exceed a capability of the terminal.

Optionally, the determining, based on whether the random access resource set is associated with at least one of eRedCap and RedCap, a random access procedure for which the random access resource set is not available includes at least one of the following:

in a case that all random access resource sets indicated to the terminal and including four-step random access resources are not associated with eRedCap, the random access resource set is associated with RedCap, and the random access resource set includes four-step random access resources, determining a random access procedure for which the random access resource set is not available includes a random access procedure for which eRedCap or RedCap is not applicable; and

in a case that all random access resource sets indicated to the terminal and including four-step random access resources are not associated with eRedCap, the random access resource set is associated with RedCap, and the random access resource set includes only two-step random access resources, determining a random access procedure for which the random access resource set is not available includes a random access procedure for which eRedCap or RedCap is not applicable.

Optionally, the in a case that all random access resource sets indicated to the terminal and including four-step random access resources are not associated with eRedCap, the random access resource set is associated with RedCap, and the random access resource set includes only two-step random access resources, determining a random access procedure for which the random access resource set is not available includes a random access procedure for which eRedCap or RedCap is not applicable includes:

in a case that all random access resource sets indicated to the terminal and including four-step random access resources are not associated with eRedCap, the random access resource set is associated with RedCap, the random access resource set includes only two-step random access resources, and the two-step random access resources satisfy a second condition, determining a random access procedure for which the random access resource set is not available includes a random access procedure for which eRedCap or RedCap is not applicable, where the second condition includes that part or all of time-frequency resources for transmitting message A of the two-step random access resources do not exceed a capability of the terminal.

Optionally, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap or RedCap is not applicable; and

in a case that the random access resource set is associated with RedCap and the random access resource set includes only two-step random access resources, determining a random access procedure for which the random access resource set is not available includes a random access procedure for which eRedCap or RedCap is not applicable.

Optionally, the in a case that the random access resource set is associated with RedCap and the random access resource set includes only two-step random access resources, determining a random access procedure for which the random access resource set is not available includes a random access procedure for which eRedCap or RedCap is not applicable includes:

in a case that the random access resource set is associated with RedCap, the random access resource set includes only two-step random access resources, and the two-step random access resources satisfy a third condition, determining a random access procedure for which the random access resource set is not available includes a random access procedure for which eRedCap or RedCap is not applicable, where the third condition includes that part or all of time-frequency resources for transmitting message A of the two-step random access resources do not exceed a capability of the terminal.

Optionally, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap or RedCap is not applicable; and

in a case that the random access resource set is associated with RedCap and the random access resource set includes only two-step random access resources, determining a random access procedure for which the random access resource set is not available includes a random access procedure for which eRedCap or RedCap is not applicable.

Optionally, the in a case that the random access resource set is associated with RedCap and the random access resource set includes only two-step random access resources, determining a random access procedure for which the random access resource set is not available includes a random access procedure for which eRedCap or RedCap is not applicable includes:

in a case that the random access resource set is associated with RedCap, the random access resource set includes only two-step random access resources, and the two-step random access resources satisfy a fourth condition, determining a random access procedure for which the random access resource set is not available includes a random access procedure for which eRedCap or RedCap is not applicable, where the fourth condition includes that part or all of time-frequency resources for transmitting message A of the two-step random access resources do not exceed a capability of the terminal.

The above random access resource set determination apparatus can enhance the random access performance of the terminal.

The random access resource set determination apparatus in the embodiments of the present application may be an electronic device, for example, an electronic device having an operating system, or a component in an electronic device, such as an integrated circuit or a chip. For example, the electronic device may be a terminal or another device other than a terminal. Exemplarily, the terminal may include, but is not limited to, the types of terminals listed in the embodiments of the present application. Other devices may include servers, network attached storage (NAS), etc., which are not specifically limited in the embodiments of the present application.

The random access resource set determination apparatus according to the embodiments of the present application can implement the processes implemented in the method embodiments in FIG. 2 and achieve the same technical effects. To avoid repetition, a detailed description is omitted herein.

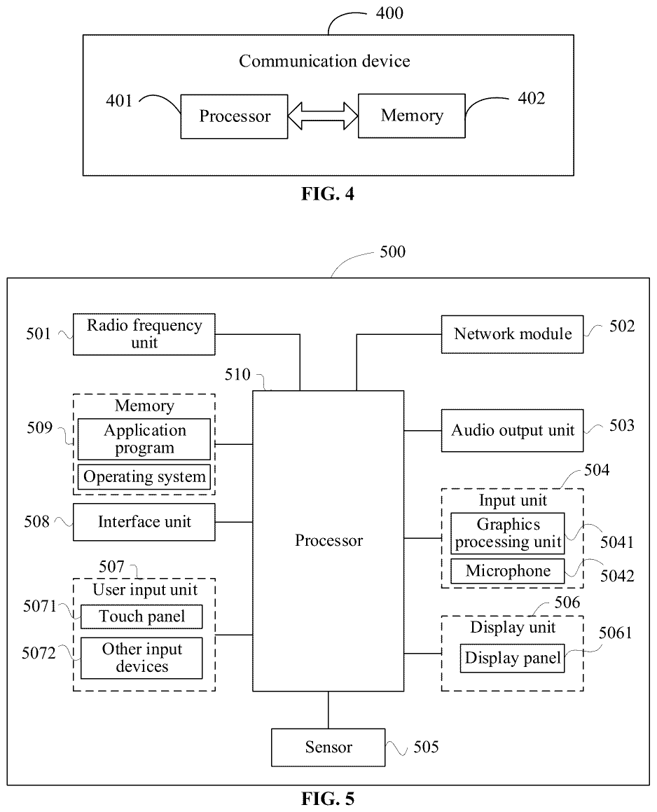

Optionally, as shown in FIG. 4, the embodiments of the present application further provide a communication device 400, which includes a processor 401 and a memory 402. The memory 402 has programs or instructions executable by the processor 401 stored therein. For example, when the communication device 400 is a first terminal, the programs or instructions, when executed by the processor 401, implement steps of the above measurement method or measurement indication method embodiments and achieve the same technical effects. To avoid repetition, a detailed description is omitted herein.

The embodiments of the present application further provide a communication device including a processor and a communication interface, the processor being configured to perform an availability determination operation on a random access resource set, where the availability determination operation includes: determining, based on whether the random access resource set is associated with at least one of eRedCap configuration and RedCap, a random access procedure for which the random access resource set is not available. The communication device embodiment corresponds to the above measurement method embodiments. The processes and implementations of the above method embodiments are applicable to the communication device embodiment and can achieve the same technical effects.

In particular, FIG. 5 is a schematic diagram of a hardware structure of a terminal for implementing an embodiment of the present application.

The terminal 500 includes, but is not limited to, at least part of the following components: a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (e.g., a battery) configured to provide power to the components. The power supply can be logically connected to the processor 510 via a power management system, thereby enabling the management of charging, discharging, and power consumption through the power management system. The terminal structure shown in FIG. 5 constitutes no limitation on the terminal. The terminal may include more or fewer components than those illustrated, may combine certain components, or may have different component arrangements, which are not further described herein.

It is to be understood that, in the embodiments of the present application, the input unit 504 may include a graphics processing unit (GPU) 5041 and a microphone 5042. The graphics processing unit 5041 processes image data of static images or videos captured by an image capture apparatus (such as a camera) in video capture mode or image capture mode. The display unit 506 may include a display panel 5061. The display panel 5061 may be configured in the form of a liquid crystal display, an organic light-emitting diode, or the like. The user input unit 507 includes at least one of a touch panel 5071 and other input terminals 5072. The touch panel 5071 is also referred to as a touchscreen. The touch panel 5071 may include two parts: a touch detection apparatus and a touch controller. Other input terminals 5072 may include, but are not limited to, a physical keyboard, function keys (e.g., volume control keys, power keys, etc.), a trackball, a mouse, or a joystick, which are not further described herein.

In the embodiments of the present application, the radio frequency unit 501 may transmit downlink data received from a network-side terminal to the processor 510 for processing. Additionally, the radio frequency unit 501 may transmit uplink data to the network-side terminal. Generally, the radio frequency unit 501 includes, but is not limited to, an antenna, an amplifier, a transceiver, a coupler, a low-noise amplifier, and a duplexer.

The memory 509 may be configured to store software programs or instructions, as well as various data. The memory 509 may mainly include a first storage area for storing programs or instructions and a second storage area for storing data. The first storage area may store an operating system, at least one application program or instruction required for a function (such as audio playback, image playback, etc.), and the like. In addition, the memory 509 may include a volatile memory or a non-volatile memory, or the memory 509 may include both the volatile memory and the non-volatile memory. The non-volatile memory may be read-only memory (ROM), programmable ROM (Programmable ROM, PROM), erasable PROM (Erasable PROM, EPROM), electrically EPROM (Electrically EPROM, EEPROM), or flash memory. The volatile memory may include random access memory (RAM), static RAM (Static RAM, SRAM), dynamic RAM (Dynamic RAM, DRAM), synchronous DRAM (Synchronous DRAM, SDRAM), double data rate SDRAM (Double Data Rate SDRAM, DDRSDRAM), enhanced SDRAM (Enhanced SDRAM, ESDRAM), Synch link DRAM (Synch link DRAM, SLDRAM), or Direct Rambus RAM (Direct Rambus RAM, DRRAM). The memory 509 in the embodiments of the present application includes, but is not limited to, the above types of memory and any other suitable types of memory.

The processor 510 may include one or more processing units. Optionally, the processor 510 integrates an application processor and a modem processor. The application processor primarily handles operations related to the operating system, user interface, application programs, and the like. The modem processor primarily handles wireless communication signals, such as a baseband processor. It can be understood that the above modem processor may not be integrated into the processor 510.

The processor 510 is configured to perform an availability determination operation on a random access resource set, where the availability determination operation includes:

determining, based on whether the random access resource set is associated with at least one of enhanced reduced capability eRedCap configuration and reduced capability RedCap, a random access procedure for which the random access resource set is not available.

Optionally, the random access resource set includes:

any random access resource set of random access resource sets indicated to the terminal.

Optionally, the random access resource set includes at least one of the following:

a resource set including only four-step random access resources, a resource set including only two-step random access resources, and a resource set including both four-step random access resources and two-step random access resources.

Optionally, the determining, based on whether the random access resource set is associated with at least one of eRedCap and RedCap, a random access procedure for which the random access resource set is not available includes at least one of the following:

in a case that the random access resource set is associated with eRedCap, determining a random access procedure for which the random access resource set is not available includes a random access procedure for which eRedCap is not applicable.

Optionally, the terminal is an eRedCap terminal, and the method further includes at least one of the following:

in a case that the random access resource set is not associated with eRedCap, the terminal regards the terminal as a RedCap terminal to perform at least one of the following:

performing an availability determination operation on the random access resource set; and selecting, based on priorities of features, a random access resource set.

Optionally, the terminal is an eRedCap terminal, and in a case that the random access resource set is not associated with eRedCap, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap is not applicable;

in a case that the random access resource set is associated with RedCap and the random access resource set includes only two-step random access resources, determining a random access procedure for which the random access resource set is not available includes a random access procedure for which eRedCap is not applicable; and

in a case that the random access resource set is associated with RedCap and the random access resource set includes only two-step random access resources, determining a random access procedure for which the random access resource set is not available includes a random access procedure for which eRedCap is not applicable and a random access procedure for which RedCap is not applicable.

Optionally, the in a case that the random access resource set is associated with RedCap and the random access resource set includes only two-step random access resources, determining a random access procedure for which the random access resource set is not available includes a random access procedure for which eRedCap is not applicable includes:

in a case that the random access resource set is associated with RedCap, the random access resource set includes only two-step random access resources, and the two-step random access resources satisfy a first condition, determining a random access procedure for which the random access resource set is not available includes a random access procedure for which eRedCap is not applicable;

or

the in a case that the random access resource set is associated with RedCap and the random access resource set includes only two-step random access resources, determining a random access procedure for which the random access resource set is not available includes a random access procedure for which eRedCap is not applicable and a random access procedure for which RedCap is not applicable includes:

in a case that the random access resource set is associated with RedCap, the random access resource set includes only two-step random access resources, and the two-step random access resources satisfy a first condition, determining a random access procedure for which the random access resource set is not available includes a random access procedure for which eRedCap is not applicable and a random access procedure for which RedCap is not applicable,

where the first condition includes that part or all of time-frequency resources for transmitting message A of the two-step random access resources do not exceed a capability of the terminal.

Optionally, the determining, based on whether the random access resource set is associated with at least one of eRedCap and RedCap, a random access procedure for which the random access resource set is not available includes at least one of the following:

in a case that all random access resource sets indicated to the terminal and including four-step random access resources are not associated with eRedCap, the random access resource set is associated with RedCap, and the random access resource set includes four-step random access resources, determining a random access procedure for which the random access resource set is not available includes a random access procedure for which eRedCap or RedCap is not applicable; and

in a case that all random access resource sets indicated to the terminal and including four-step random access resources are not associated with eRedCap, the random access resource set is associated with RedCap, and the random access resource set includes only two-step random access resources, determining a random access procedure for which the random access resource set is not available includes a random access procedure for which eRedCap or RedCap is not applicable.

Optionally, the in a case that all random access resource sets indicated to the terminal and including four-step random access resources are not associated with eRedCap, the random access resource set is associated with RedCap, and the random access resource set includes only two-step random access resources, determining a random access procedure for which the random access resource set is not available includes a random access procedure for which eRedCap or RedCap is not applicable includes:

in a case that all random access resource sets indicated to the terminal and including four-step random access resources are not associated with eRedCap, the random access resource set is associated with RedCap, the random access resource set includes only two-step random access resources, and the two-step random access resources satisfy a second condition, determining a random access procedure for which the random access resource set is not available includes a random access procedure for which eRedCap or RedCap is not applicable, where the second condition includes that part or all of time-frequency resources for transmitting message A of the two-step random access resources do not exceed a capability of the terminal.

Optionally, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap or RedCap is not applicable; and

in a case that the random access resource set is associated with RedCap and the random access resource set includes only two-step random access resources, determining a random access procedure for which the random access resource set is not available includes a random access procedure for which eRedCap or RedCap is not applicable.

Optionally, the in a case that the random access resource set is associated with RedCap and the random access resource set includes only two-step random access resources, determining a random access procedure for which the random access resource set is not available includes a random access procedure for which eRedCap or RedCap is not applicable includes:

in a case that the random access resource set is associated with RedCap, the random access resource set includes only two-step random access resources, and the two-step random access resources satisfy a third condition, determining a random access procedure for which the random access resource set is not available includes a random access procedure for which eRedCap or RedCap is not applicable, where the third condition includes that part or all of time-frequency resources for transmitting message A of the two-step random access resources do not exceed a capability of the terminal.

Optionally, the determining, based on whether the random access resource set is associated with at least one of eRedCap and RedCap, a random access procedure for which the random access resource set is not available includes at least one of the following:

in a case that the random access resource set is associated with RedCap and the random access resource set includes four-step random access resources, determining a random access procedure for which the random access resource set is not available includes a random access procedure for which eRedCap or RedCap is not applicable; and

in a case that the random access resource set is associated with RedCap and the random access resource set includes only two-step random access resources, determining a random access procedure for which the random access resource set is not available includes a random access procedure for which eRedCap or RedCap is not applicable.

Optionally, the in a case that the random access resource set is associated with RedCap and the random access resource set includes only two-step random access resources, determining a random access procedure for which the random access resource set is not available includes a random access procedure for which eRedCap or RedCap is not applicable includes:

in a case that the random access resource set is associated with RedCap, the random access resource set includes only two-step random access resources, and the two-step random access resources satisfy a fourth condition, determining a random access procedure for which the random access resource set is not available includes a random access procedure for which eRedCap or RedCap is not applicable, where the fourth condition includes that part or all of time-frequency resources for transmitting message A of the two-step random access resources do not exceed a capability of the terminal.

The above terminal can enhance the random access performance of the terminal.

It can be understood that the implementation processes of the implementations described in this embodiment may refer to the related description of the above measurement method, and can achieve the same or equivalent technical effects. To avoid repetition, a detailed description is omitted herein.

The embodiments of the present application further provide a readable storage medium having programs or instructions stored therein. The programs or instructions, when executed by a processor, implement the processes of the above random access resource set determination method embodiments and achieve the same technical effects. To avoid repetition, a detailed description is omitted herein.

The processor is a processor of the terminal described in the above embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

The embodiments of the present application further provide a chip including a processor and a communication interface. The communication interface is coupled to the processor. The processor is configured to execute programs or instructions to implement the processes of the above random access resource set determination method embodiments and achieve the same technical effects. To avoid repetition, a detailed description is omitted herein.

It is to be understood that the chip mentioned in the embodiments of the present application may be referred to as a system-on-chip, a system chip, a chip system, or an on-chip system, and the like.

The embodiments of the present application further provide a computer program/program product stored on a storage medium, the program/program product being executed by at least one processor to implement the processes of the above random access resource set determination method embodiments and achieve the same technical effects. To avoid repetition, a detailed description is omitted herein.

It is to be noted that, as used herein, the terms “include”, “comprise”, and any of other variants are intended to encompass non-exclusive inclusion, such that a process, method, article, or apparatus that includes a series of elements not only includes those elements but also may include other elements not explicitly listed, or elements inherent to such a process, method, article, or apparatus. In the absence of further limitations, an element defined by the statement “including one . . . ” does not exclude the presence of additional identical elements in a process, method, article, or apparatus that includes the element. In addition, it is to be noted that the scope of the method and apparatus in implementations of the present application is not limited to performing functions in the order shown or discussed. Functions may be performed substantially simultaneously or in an order opposite to that described. For example, the method described may be executed in an order different from that illustrated, and various steps may be added, omitted, or combined. Additionally, features described in reference to certain examples may be combined in other examples.

From the description of the above implementations, a person skilled in the art can clearly understand that the methods of the above embodiments can be implemented by a computer software product together with a necessary general-purpose hardware platform, or, alternatively, entirely by hardware. The computer software product is stored in a storage medium (such as ROM, RAM, magnetic disk, optical disk, etc.) and includes multiple instructions configured to cause a terminal or a network-side device to perform the methods described in the embodiments of the present application.

The embodiments of the present application have been described above with reference to the drawings. However, the present application is not limited to the specific implementations described above. The above specific implementations are illustrative rather than restrictive. A person of ordinary skill in the art, in light of the teachings of the present application, may make various modifications and variations without departing from the scope of the spirit of the present application and the claims, all of which are intended to be encompassed within the protection of the present application.

What is claimed is:

1. A random access resource set determination method, comprising:
performing, by a terminal, an availability determination operation on a random access resource set, wherein the availability determination operation comprises:
determining, based on whether the random access resource set is associated with at least one of enhanced reduced capability (eRedCap) or reduced capability (RedCap), a random access procedure for which the random access resource set is not available.

2. The method according to claim 1, wherein the determining, based on whether the random access resource set is associated with at least one of eRedCap or RedCap, a random access procedure for which the random access resource set is not available comprises at least one of the following:
in a case that all random access resource sets indicated to the terminal and comprising four-step random access resources are not associated with eRedCap, the random access resource set is associated with RedCap, and the random access resource set comprises four-step random access resources, determining a random access procedure for which the random access resource set is not available comprises a random access procedure for which eRedCap or RedCap is not applicable; or
in a case that all random access resource sets indicated to the terminal and comprising four-step random access resources are not associated with eRedCap, the random access resource set is associated with RedCap, and the random access resource set comprises only two-step random access resources, determining a random access procedure for which the random access resource set is not available comprises a random access procedure for which eRedCap or RedCap is not applicable.

3. The method according to claim 2, wherein the in a case that all random access resource sets indicated to the terminal and comprising four-step random access resources are not associated with eRedCap, the random access resource set is associated with RedCap, and the random access resource set comprises only two-step random access resources, determining a random access procedure for which the random access resource set is not available comprises a random access procedure for which eRedCap or RedCap is not applicable comprises:
in a case that all random access resource sets indicated to the terminal and comprising four-step random access resources are not associated with eRedCap, the random access resource set is associated with RedCap, the random access resource set comprises only two-step random access resources, and the two-step random access resources satisfy a second condition, determining a random access procedure for which the random access resource set is not available comprises a random access procedure for which eRedCap or RedCap is not applicable, wherein the second condition comprises that part or all of time-frequency resources for transmitting message A of the two-step random access resources do not exceed a capability of the terminal.

4. The method according to claim 1, wherein the random access resource set comprises:
any random access resource set of random access resource sets indicated to the terminal.

5. The method according to claim 1, wherein the random access resource set comprises at least one of the following:
a resource set comprising only four-step random access resources, a resource set comprising only two-step random access resources, or a resource set comprising both four-step random access resources and two-step random access resources.

6. The method according to claim 5, wherein the determining, based on whether the random access resource set is associated with at least one of eRedCap or RedCap, a random access procedure for which the random access resource set is not available comprises at least one of the following:
in a case that the random access resource set is associated with eRedCap, determining a random access procedure for which the random access resource set is not available comprises a random access procedure for which eRedCap is not applicable.

7. The method according to claim 1, wherein the terminal is an eRedCap terminal, and the method further comprises at least one of the following:
in a case that the random access resource set is not associated with eRedCap, the terminal regards the terminal as a RedCap terminal to perform at least one of the following:
performing an availability determination operation on the random access resource set; or selecting, based on priorities of features, a random access resource set.

8. The method according to claim 1, wherein the terminal is an eRedCap terminal, and in a case that the random access resource set is not associated with eRedCap, the determining, based on whether the random access resource set is associated with at least one of eRedCap or RedCap, a random access procedure for which the random access resource set is not available comprises at least one of the following:
in a case that the random access resource set is associated with RedCap and the random access resource set comprises four-step random access resources, determining a random access procedure for which the random access resource set is not available comprises a random access procedure for which eRedCap is not applicable;
in a case that the random access resource set is associated with RedCap and the random access resource set comprises only two-step random access resources, determining a random access procedure for which the random access resource set is not available comprises a random access procedure for which eRedCap is not applicable; or
in a case that the random access resource set is associated with RedCap and the random access resource set comprises only two-step random access resources, determining a random access procedure for which the random access resource set is not available comprises a random access procedure for which eRedCap is not applicable and a random access procedure for which RedCap is not applicable.

9. The method according to claim 8, wherein the in a case that the random access resource set is associated with RedCap and the random access resource set comprises only two-step random access resources, determining a random access procedure for which the random access resource set is not available comprises a random access procedure for which eRedCap is not applicable comprises:
in a case that the random access resource set is associated with RedCap, the random access resource set comprises only two-step random access resources, and the two-step random access resources satisfy a first condition, determining a random access procedure for which the random access resource set is not available comprises a random access procedure for which eRedCap is not applicable;
or
the in a case that the random access resource set is associated with RedCap and the random access resource set comprises only two-step random access resources, determining a random access procedure for which the random access resource set is not available comprises a random access procedure for which eRedCap is not applicable and a random access procedure for which RedCap is not applicable comprises:
in a case that the random access resource set is associated with RedCap, the random access resource set comprises only two-step random access resources, and the two-step random access resources satisfy a first condition, determining a random access procedure for which the random access resource set is not available comprises a random access procedure for which eRedCap is not applicable and a random access procedure for which RedCap is not applicable,
wherein the first condition comprises that part or all of time-frequency resources for transmitting message A of the two-step random access resources do not exceed a capability of the terminal.

10. The method according to claim 1, wherein the determining, based on whether the random access resource set is associated with at least one of eRedCap or RedCap, a random access procedure for which the random access resource set is not available comprises at least one of the following:
in a case that the random access resource set is associated with RedCap and the random access resource set comprises four-step random access resources, determining a random access procedure for which the random access resource set is not available comprises a random access procedure for which eRedCap or RedCap is not applicable; or
in a case that the random access resource set is associated with RedCap and the random access resource set comprises only two-step random access resources, determining a random access procedure for which the random access resource set is not available comprises a random access procedure for which eRedCap or RedCap is not applicable.

11. The method according to claim 10, wherein the in a case that the random access resource set is associated with RedCap and the random access resource set comprises only two-step random access resources, determining a random access procedure for which the random access resource set is not available comprises a random access procedure for which eRedCap or RedCap is not applicable comprises:
in a case that the random access resource set is associated with RedCap, the random access resource set comprises only two-step random access resources, and the two-step random access resources satisfy a third condition, determining a random access procedure for which the random access resource set is not available comprises a random access procedure for which eRedCap or RedCap is not applicable, wherein the third condition comprises that part or all of time-frequency resources for transmitting message A of the two-step random access resources do not exceed a capability of the terminal.

12. The method according to claim 1, wherein the determining, based on whether the random access resource set is associated with at least one of eRedCap or RedCap, a random access procedure for which the random access resource set is not available comprises at least one of the following:
in a case that the random access resource set is associated with RedCap and the random access resource set comprises four-step random access resources, determining a random access procedure for which the random access resource set is not available comprises a random access procedure for which eRedCap or RedCap is not applicable; or
in a case that the random access resource set is associated with RedCap and the random access resource set comprises only two-step random access resources, determining a random access procedure for which the random access resource set is not available comprises a random access procedure for which eRedCap or RedCap is not applicable.

13. The method according to claim 12, wherein the in a case that the random access resource set is associated with RedCap and the random access resource set comprises only two-step random access resources, determining a random access procedure for which the random access resource set is not available comprises a random access procedure for which eRedCap or RedCap is not applicable comprises:
in a case that the random access resource set is associated with RedCap, the random access resource set comprises only two-step random access resources, and the two-step random access resources satisfy a fourth condition, determining a random access procedure for which the random access resource set is not available comprises a random access procedure for which eRedCap or RedCap is not applicable, wherein the fourth condition comprises that part or all of time-frequency resources for transmitting message A of the two-step random access resources do not exceed a capability of the terminal.

14. A terminal comprising a processor and a memory, the memory storing programs or instructions executable by the processor, wherein the programs or the instructions, when executed by the processor, cause the terminal to perform:
performing an availability determination operation on a random access resource set, wherein the availability determination operation comprises:
determining, based on whether the random access resource set is associated with at least one of enhanced reduced capability (eRedCap) or reduced capability (RedCap), a random access procedure for which the random access resource set is not available.

15. The terminal according to claim 14, wherein when determining, based on whether the random access resource set is associated with at least one of eRedCap or RedCap, a random access procedure for which the random access resource set is not available, the programs or the instructions, when executed by the processor, cause the terminal to perform at least one of the following:
in a case that all random access resource sets indicated to the terminal and comprising four-step random access resources are not associated with eRedCap, the random access resource set is associated with RedCap, and the random access resource set comprises four-step random access resources, determining a random access procedure for which the random access resource set is not available comprises a random access procedure for which eRedCap or RedCap is not applicable; or
in a case that all random access resource sets indicated to the terminal and comprising four-step random access resources are not associated with eRedCap, the random access resource set is associated with RedCap, and the random access resource set comprises only two-step random access resources, determining a random access procedure for which the random access resource set is not available comprises a random access procedure for which eRedCap or RedCap is not applicable.

16. The terminal according to claim 15, wherein when in a case that all random access resource sets indicated to the terminal and comprising four-step random access resources are not associated with eRedCap, the random access resource set is associated with RedCap, and the random access resource set comprises only two-step random access resources, determining a random access procedure for which the random access resource set is not available comprises a random access procedure for which eRedCap or RedCap is not applicable, the programs or the instructions, when executed by the processor, cause the terminal to perform:
in a case that all random access resource sets indicated to the terminal and comprising four-step random access resources are not associated with eRedCap, the random access resource set is associated with RedCap, the random access resource set comprises only two-step random access resources, and the two-step random access resources satisfy a second condition, determining a random access procedure for which the random access resource set is not available comprises a random access procedure for which eRedCap or RedCap is not applicable, wherein the second condition comprises that part or all of time-frequency resources for transmitting message A of the two-step random access resources do not exceed a capability of the terminal.

17. A non-transitory readable storage medium having programs or instructions stored therein, the programs or the instructions, when executed by a processor of a terminal, cause the processor to perform:
performing an availability determination operation on a random access resource set, wherein the availability determination operation comprises:
determining, based on whether the random access resource set is associated with at least one of enhanced reduced capability (eRedCap) or reduced capability (RedCap), a random access procedure for which the random access resource set is not available.

18. The non-transitory readable storage medium according to claim 17, wherein when determining, based on whether the random access resource set is associated with at least one of eRedCap or RedCap, a random access procedure for which the random access resource set is not available, the programs or the instructions, when executed by the processor, cause the processor to perform at least one of the following:
in a case that all random access resource sets indicated to the terminal and comprising four-step random access resources are not associated with eRedCap, the random access resource set is associated with RedCap, and the random access resource set comprises four-step random access resources, determining a random access procedure for which the random access resource set is not available comprises a random access procedure for which eRedCap or RedCap is not applicable; or
in a case that all random access resource sets indicated to the terminal and comprising four-step random access resources are not associated with eRedCap, the random access resource set is associated with RedCap, and the random access resource set comprises only two-step random access resources, determining a random access procedure for which the random access resource set is not available comprises a random access procedure for which eRedCap or RedCap is not applicable.

19. The non-transitory readable storage medium according to claim 18, wherein when in a case that all random access resource sets indicated to the terminal and comprising four-step random access resources are not associated with eRedCap, the random access resource set is associated with RedCap, and the random access resource set comprises only two-step random access resources, determining a random access procedure for which the random access resource set is not available comprises a random access procedure for which eRedCap or RedCap is not applicable, the programs or the instructions, when executed by the processor, cause the processor to perform:
in a case that all random access resource sets indicated to the terminal and comprising four-step random access resources are not associated with eRedCap, the random access resource set is associated with RedCap, the random access resource set comprises only two-step random access resources, and the two-step random access resources satisfy a second condition, determining a random access procedure for which the random access resource set is not available comprises a random access procedure for which eRedCap or RedCap is not applicable, wherein the second condition comprises that part or all of time-frequency resources for transmitting message A of the two-step random access resources do not exceed a capability of the terminal.

20. A chip comprising a processor and a communication interface, the communication interface being coupled to the processor, and the processor being configured to execute programs or instructions to implement the random access resource set determination method according to claim 1.
